(19) United States
(12) Patent Application Publication
(10) Pub. No.: US 2006/0180706 A1
(43) Pub. Date: Aug. 17, 2006

(54) Method for seizing an object

(76) Inventors: Sergey Vladimirovich Antonenko, Moscow (RU); Sergey Andreevich Belavskii, Moscow (RU)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/525,692

(22) PCT Filed: Aug. 20, 2003
(86) PCT No.: PCT/RU03/00373

§ 371 Date: Jul. 18, 2005

(30) Foreign Application Priority Data
Aug. 21, 2002 (RU) 2002122432

(51) Int. Cl. B64C 1/22

(52) U.S. Cl. 244/137.1

(57) ABSTRACT

A method for gripping an object by another gripping object comprises the steps of: detaching a part of an object to be gripped while maintaining a mechanical link; retaining the detachable part at a distance “a” from the object to be gripped by a part of the gripping object by spatial movement of the latter. At least a certain time period before the moment of engagement, there is the step of stabilizing an angle position of the detachable part relative to the object to be gripped by rotating said part to provide it with own angular momentum directed at an angle “ε” to the object to be gripped. A reactive force F and/or an aerodynamic force R are (is) used as the retaining force. At the same time, the aerodynamic force R is generated by rotation of the detachable part. The rotating detachable part is oriented relative to the object to be gripped by generating an orienting aerodynamic force P on said part, said orienting aerodynamic force being directed at an angle to the object to be gripped.

The invention relates to means for gripping objects in operations of rescuing the same.

Known from the technical literature is a method for gripping an object by another gripping object, comprising the steps of: detaching a part of an object to be gripped while maintaining a mechanical link; retaining the detachable part at a distance from the object to be gripped; and mechanically engaging the detachable part of the object to be gripped by a part of the gripping object by its spatial movement; the detachment step being executed before a moment of engagement, and the retaining step being executed up to the moment of engagement by generating a retaining force on the detachable part, said force being directed at an angle to the object to be gripped (“Perspektivy Razvitia Sistem Podkhvata Kosmicheskikh Apparatov v Vozdukhe” (Prospects Of Evolution Of Systems For Catching Up Spacecrafts in Air). Technical translation No 756. “AJAA Paper”, No 68-1163. “Voyennaya Aviatsia i Raketnaya Tekhnika” (Military Aviation and Rocket Engineering), issue 8, 1970, pp. 15-21. “Flug-Revue”, 1964, No 1, p. 40).

Disadvantages of said prior art method for gripping an object are its low reliability and safety, and also an insignificant range of application.

The technical problem to be solved by the invention is to improve reliability and safety of a process for gripping objects, to broaden a range of application and an arsenal of technical means.

The present problem is solved as follows: in a method for gripping an object by another gripping object, said method comprising the steps of: detaching at least one part of an object to be gripped while maintaining a mechanical link; retaining the detachable part at a distance from the object to be gripped; and mechanically engaging the at least one detachable part of the object to be gripped by at least one part of at least one gripping object by the spatial movement of at least a part of the latter; the detachment step being executed at least a certain time period before a moment of engagement, and the retaining step being executed at least up to the moment of engagement by generating at least one retaining force on the at least one detachable part, said force being directed at an angle to the object to be gripped, ACCORDING TO THE INVENTION, at least a certain time period before the moment of engagement, there is the step of at least partial stabilizing an angle position of the at least one detachable part relative to the object to be gripped by rotating said part to provide it with own angular momentum directed at an angle to the object to be gripped.

Further, according to the invention, at least one detachable part is rotated before the moment of its detachment from the object to be gripped. At least one detachable part is rotated after its detachment from the object to be gripped. At least a portion of the retaining aerodynamic force is generated by rotating at least one detachable part relative to the axis positioned at an angle to the object to be gripped. At least one detachable part is rotated using the thermal energy of combusted fuel. At least one detachable part is rotated using the electromagnetic energy. At least one detachable part is rotated using the mechanical energy. At least one detachable part is rotated using the aerodynamic energy. At least a portion of the retaining force is generated by applying a reactive force to at least one detachable part of the object to be gripped, said reactive force being directed at an angle to the object to be gripped. At least a portion of the retaining force is generated by applying an aerostatic force to at least one detachable part of the object to be gripped, said aerostatic force being directed at an angle to the object to be gripped. At least one rotating detachable part of the object to be gripped is at least partially oriented relative to the object to be gripped. At least one rotating detachable part of the object to be gripped is oriented at least a certain time period before a moment when said part starts to rotate. At least one rotating detachable part of the object to be gripped is oriented in process of rotation of said part. At least a partial orientation is carried out by generating at least one orienting force on at least one rotating detachable part of the object to be gripped, said orienting force being directed at an angle to the object to be gripped. At least one orienting force is reduced in process of rotation of the rotating detachable part of the object to be gripped. At least a portion of the orienting force is generated by applying an aerodynamic force to at least one rotating detachable part of the object to be gripped, said aerodynamic force being directed at an angle to the object to be gripped. At least a portion of the orienting force is generated by applying an aerostatic force to at least one rotating detachable part of the object to be gripped, said aerostatic force being directed at an angle to the object to be gripped. At least a partial orientation of at least one rotating detachable part of the object to be gripped is carried out before a moment of its detachment. At least a partial orientation of at least one rotating detachable part of the object to be gripped is carried out after its detachment.

An angular velocity of rotation of the rotating part of the object to be gripped is reduced at least after mechanical engagement of at least one detachable part of the object to be gripped by at least one part of at least one gripping object.

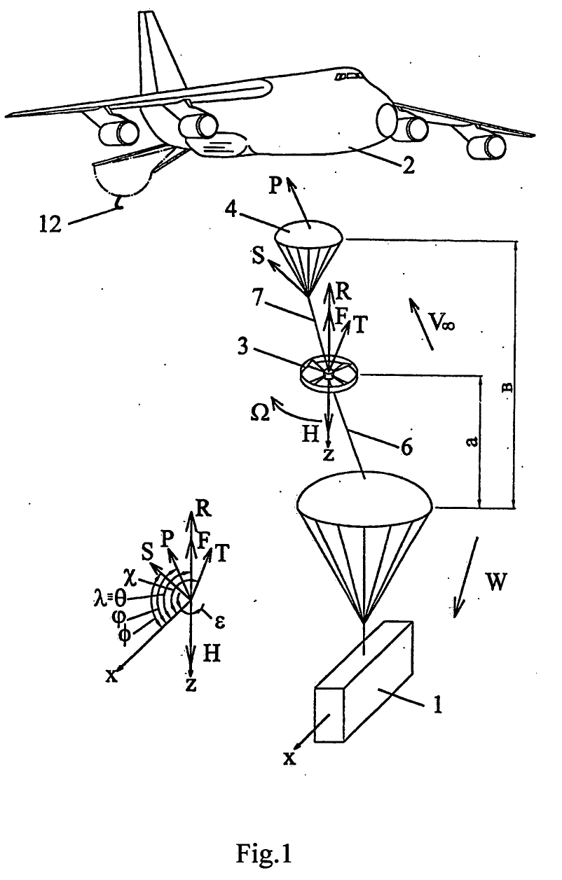

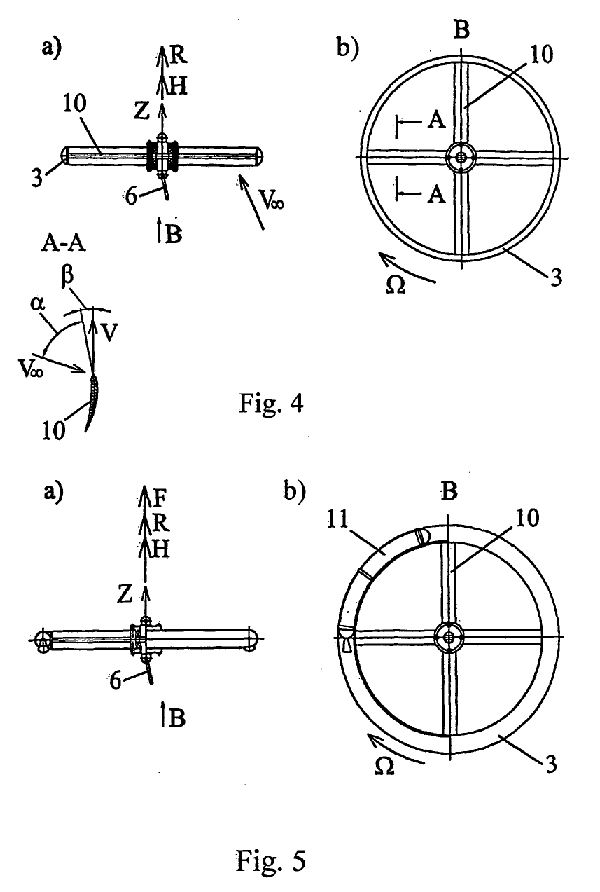

The invention will now be described in greater detail with reference to the accompanying drawings, where FIGS. 1-3 show embodiments of a gripping device, and examples of realization of the claimed method for gripping various objects by various gripping objects. FIGS. 4-9 show embodiments of some members of the claimed gripping device.

FIG. 1 shows an object 1 to be gripped and being in the form of parachuting cargo and shows a gripping object 2 as an aircraft;

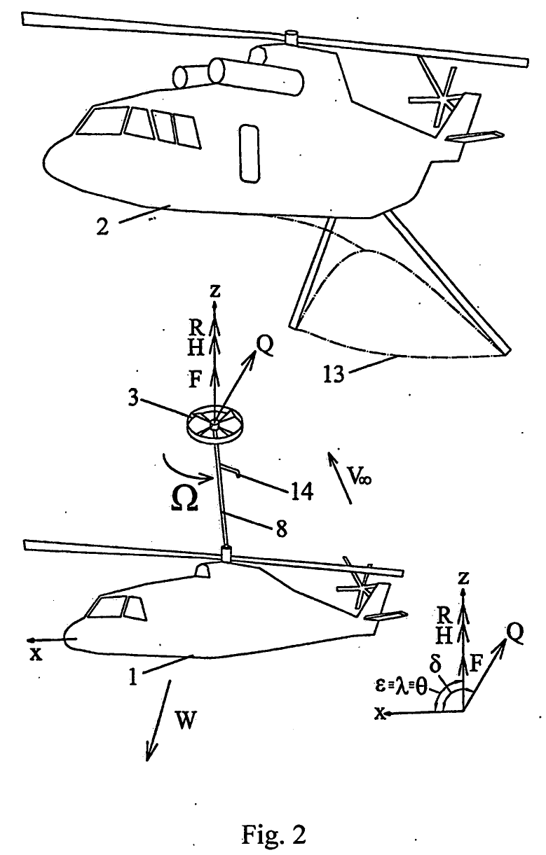

FIG. 2 shows an object 1 to be gripped as an autorotation helicopter and shows a gripping object 2 as a rescue helicopter;

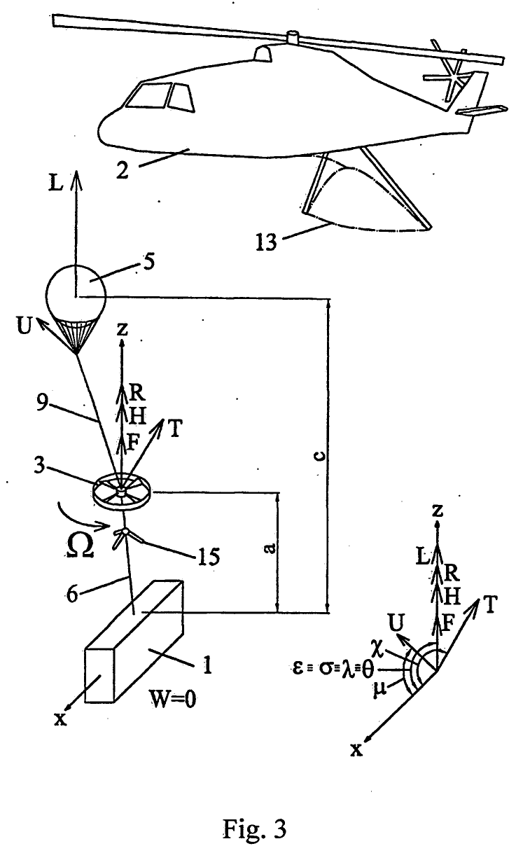

FIG. 3 shows an object 1 to be gripped as a cargo lying on a surface and shows a gripping object 2 as a helicopter;

FIGS. 4-9 show different structural embodiments of a rotating detachable part of the object 1 to be gripped, which object is implemented as a rotor 3.

The claimed method for gripping is realized as follows.

It is possible to grip the object 1 moving at a speed W, for example in the form of cargo parachuting in atmosphere, by the gripping object 2, for example by aircraft (see FIG. 1).

It is possible is to grip the object 1 moving at speed W, for example in the form of a autorotation helicopter descending in atmosphere, by the gripping object 2, for example by a rescue helicopter (see FIG. 2).

It is possible to grip the stationary object 1 (W=0), for example in the form of cargo lying on a surface, by the gripping object 2, for example by a helicopter (see FIG. 3).

It is possible to detach, for example, 2 portions implemented, for example, in the form of a rotor 3 and a parachute 4 (see FIG. 1) from the object 1 to be gripped while retaining the mechanical link with the object to be gripped.

It is possible to detach, for example, 1 portion implemented, for example, as a rotor 3 (see FIG. 2) from object 1 to be gripped while retaining the mechanical link with the object to be gripped.

It is possible to detach, for example, 2 portions implemented, for example, as a rotor 3 and an aerostat 5 (see FIG. 3) from object 1 to be gripped while retaining the mechanical link with the object to be gripped.

The mechanical link of the rotor 3 with the object 1 to be gripped can be implemented, for example, as a rope 6 whose one end is secured on the object 1 to be gripped, and the other end is secured on the rotor 3 (see FIGS. 1, 3).

The mechanical link of the parachute 4 via the rotor 3 with the object 1 to be gripped can be implemented, for example, as a rope 7 whose one end is secured on the rotor 3 and the other end is secured on the parachute 4 (see FIG. 1).

The mechanical link of the rotor 3 with the object 1 to be gripped can be implemented, for example, as a telescopic bar 8 whose one end is pivotally secured on the object 1 to be gripped and the other end is secured on the rotor 3 (see FIG. 2).

The mechanical link of the aerostat 5 via the rotor 3 with the object 1 to be gripped can be implemented, for example, as a rope 9, whose one end is secured on the rotor 3 and the other end is secured on the aerostat 5 (see FIG. 3).

After the portions implemented, for example, as the rotor 3, the parachute 4, and the aerostat 5 have been detached from the objects 1 to be gripped, said portions are retained at a distance from the objects 1 to be gripped (see FIGS. 1-3).

Possible is, for example, a partial retention of the rotor 3 at distance “a” from the object 1 to be gripped by generating a retaining force of resiliency, T, which force is directed at angle “χ”, for example, to a longitudinal axis “x” of the object 1 to be gripped, owing to selection of rigidity characteristics of the mechanical links, that is, the rope 6 and members for securing the same (see FIGS. 1, 3).

Possible is, for example, a partial retention of the parachute 4 at a distance “B” from the object 1 to be gripped by generating a retention force of resiliency, S, which force is directed at angle <<φ>>, for example, to the longitudinal axis “x” of the object 1 to be gripped, owing to selection of rigidity characteristics of the mechanical links, that is, ropes 6, 7 and members for securing the same (see FIG. 1).

Possible is, for example, retention of the rotor 3 at distance “a” from the object 1 to be gripped by generating a retention force of resiliency, Q, which force is directed at angle “δ”, for example, to the longitudinal axis “x” of the object 1 to be gripped, owing to selection of rigidity characteristics of the mechanical link, that is, a bar 8 and members for securing the same (see FIG. 2).

Possible is, for example, a partial retention of the aerostat 5 at a distance “c” from the object 1 to be gripped by generating a retention force of resiliency, U, which force is directed at angle “μ“, for example, to the longitudinal axis “x” of the object 1 to be gripped, for example, owing to selection of rigidity characteristics of the mechanical links, that is, ropes 6, 9 and members for securing the same (see FIG. 3).

Possible is, for example, retention of the rotor 3 and the parachute 4 at distances “a” and “B” from the object 1 to be gripped by generating a retaining aerodynamic force P on the parachute 4, said retaining aerodynamic force being directed at angle φ”, for example, to the longitudinal axis “x” of the object 1 to be gripped, for example, owing to the air flow that flows at a velocity V_{∞} about the parachute 4 (see FIG. 1).

Possible is, for example, a retention of the rotor 3 and the aerostat 5 at distances “a” and “c” from the object 1 to be gripped by generating a retaining aerostatic force L on the aerostat 5, said retaining aerostatic force being directed at an angle “σ”, for example, to the longitudinal axis “x” of the object 1 to be gripped (see FIG. 3).

Possible is, for example, retention of the rotor 3 at a distance “a,” from the object 1 to be gripped by generating a retaining aerodynamic force R on rotor 3, said retaining aerodynamic force being directed at angle “λ”, for example, to a longitudinal axis “x” of the object 1 to be gripped, owing to rotation the of rotor 3 at an angular velocity “Ω” relative to an axis “z” positioned at an angle “ε”, for example, to the longitudinal axis “x” of the object 1 to be gripped (FIGS. 1, 2, 3), wherein the rotor 3 can be provided, for example, with blades 10 (see FIGS. 4, 5, 6, 7, 8, 9) mounted at an angle of attack, “β”, to a circumferential velocity vector V of the rotor 3 (see FIG. 4).

Possible is, for example, retention of the rotor 3 at a distance “a” from the object 1 to be gripped by applying a retaining reactive force F to the rotor 3, said retaining reactive force being directed at angle “θ”, for example, to the longitudinal axis “x” of object 1 to be gripped (see FIGS. 1, 2, 3), wherein the rotor 3 can be provided with rocket engines 11 (see FIG. 5).

Values of the distance “a”, “B” and “c” can be selected, for example, from the safety requirements to be met when the gripping process is carried out.

Possible is mechanical engagement of a part of the object 1 to be gripped, said part being, for example, the parachute 4, by a part of the gripping object 2, said part being, for example, a hook 12, by spatial movement of the gripping object 2 (see FIG. 1).

Possible is mechanical engagement of a part of the object 1 to be gripped, said part being, for example, a hook 14 secured, for example, on the bar 8, by a part of the gripping object 2, said part being, for example, a loop 13, by spatial movement of the gripping object 2 (see FIG. 2).

Possible is mechanical engagement of a part of the object 1 to be gripped, said part being, for example, a hook 15 secured, for example, on the rope 6, by a part of the gripping object 2, said part being, for example, a loop 13, by spatial movement of gripping object 2 (see FIG. 3).

The detachment of the rotor 3 and the parachute 4 from the object 1 to be gripped is carried out according to a pre-stored program or by an additional command a certain time period before the moment when the hook 12 engages the parachute 4, and the retention of the rotor 3 and the parachute 4 at the distances “a” and B” from the object 1 to be gripped is carried out at least before the engagement moment (see FIG. 1).

The detachment of the rotor 3 from the object 1 to be gripped is carried out according to a pre-stored program or by an additional command a certain time period before the moment when the loop 13 engages the hook 14, and the retention of the rotor 3 and at the distance “a” from the object 1 to be gripped is carried out at least before the engagement moment (see FIG. 2).

The detachment of the rotor 3 and the aerostat 5 from the object 1 to be gripped is carried out according to a pre-stored program or by an additional command a certain time period before the moment when the loop 13 engages the hook 15, and the retention of the rotor 3 and the aerostat 5 at the distances “a” and “c” from the object 1 to be gripped is carried out at least before the engagement moment (see FIG. 3).

A command to detach, for example, the rotor 3, the parachute 4, and the aerostat 5 may be issued a certain time period before the engagement moment from both the object 1 to be gripped and the gripping object 2, for example by a radio signal.

To facilitate the process of engaging the parachute 4 by the hook 12, at least a certain time period before the engagement moment, it is possible to stabilize an angular position of the rotor 3 relative to the object 1 to be gripped by rotation of the rotor 3 at an angular velocity “Ω”, which rotor has a moment of inertia, I, so that to impart to said rotor its own angular momentum H=I*Ω directed at an angle “ε”, for example, to the longitudinal axis “x” of the object 1 to be gripped (see FIG. 1). At the same time, the parachute 4 is stabilized relative to the object 1 to be gripped (i.e. a position under action of perturbing factors is retained) owing to:

rigidity of mechanical links of the rotor 3, that is, the ropes 6, 7 and members for securing the same on the rotor 3 (see FIG. 1);

stabilization of the retaining forces generated on the rotor 3, for example, the aerodynamic force R and/or the reactive force F (FIG. 1).

An angular position of the rotor 3 having its own angular momentum H is stabilized (i.e. an angular position under action of perturbing factors is retained) because of its gyroscopic properties.

To facilitate the engagement of the hook 14 by the loop 13, at least a certain time period before the engagement moment, it is possible to stabilize an angular position of the rotor 3 relative to the object 1 to be gripped by rotation of the rotor 3 at an angular velocity “Ω”, which rotor has a moment of inertia, I, so that to impart to said rotor its own angular momentum H=I*Ω directed at an angle “ε”, for example, to the longitudinal axis “x” of the object 1 to be gripped (see FIG. 2). At the same time, the bar 8 and thereby the hook 14 are stabilized relative to the object 1 to be gripped (i.e. a position under action of perturbing factors is retained) owing to:

rigidity of mechanical links of the rotor 3, that is, the bar 8 and the member for securing the same on the rotor 3 (see FIG. 2);

stabilization of the retaining forces generated on the rotor 3, for example of the aerodynamic force R and/or the reactive force F (see FIG. 2).

To facilitate the engagement of the hook 15 by the loop 13, at least a certain time period before the engagement moment, it is possible to stabilize an angular position of the rotor 3 relative to the object 1 to be gripped by rotation of the rotor 3 at an angular velocity “Ω”, which rotor has a moment of inertia, I, so that to impart to said rotor its own angular momentum H=I*Ω directed at an angle “ε”, for example, to the longitudinal axis “x” of the object 1 to be gripped (see FIG. 3). At the same time, the rope 6 and thereby the hook 15 are stabilized relative to the object 1 to be gripped (i.e. a position under action of perturbing factors is retained) owing to:

rigidity mechanical links of the rotor 3, that is, the rope 6 and the member for securing the same on the rotor 3 (see FIG. 3);

stabilization of the retaining forces generated on the rotor 3, for example of the aerodynamic force R and/or the reactive force F (see FIG. 3).

The rotor 3 can be rotated before it is detached from the object 1 to be gripped and/or after said detachment.

The rotor 3 can be rotated relative to the axis “z” directed at an angle “ε”, for example, to the longitudinal axis “x” of the object 1 to be gripped using a drive that can be positioned on both the rotor 3 and the object 1 to be gripped (see FIGS. 1, 2, 3), and which drive also can use energy of different nature for its operation:

mechanical energy;

aerodynamic energy;

electromagnetic energy;

thermal energy;

and others.

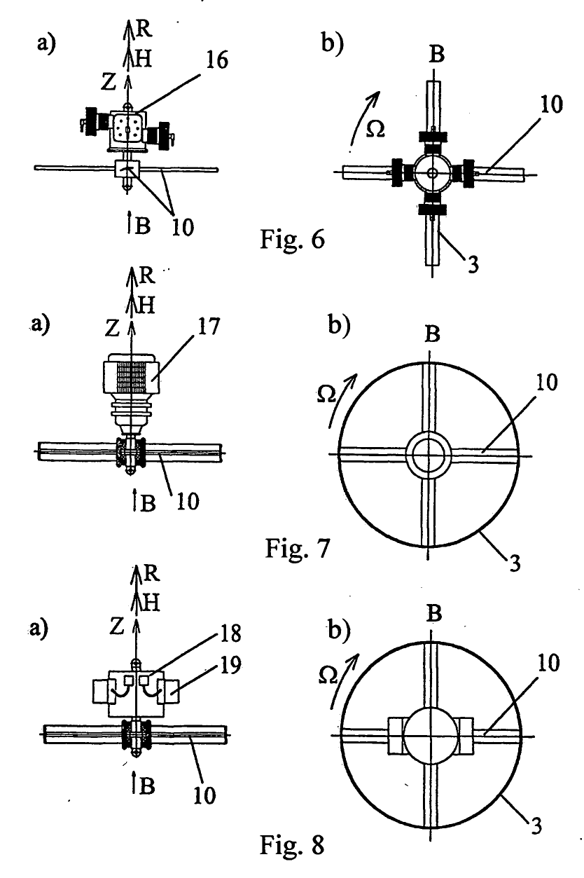

The rotor 3 can be rotated both before its detachment from the object 1 to be gripped and after said detachment, for example, using the thermal energy of combusted fuel, wherein the rotor 3 can be provided with an independent rotary drive including rocket engines 11 (see FIG. 5), an internal combustion engine 16 (see FIG. 6), a gas-turbine unit 17 (see FIG. 7), and others.

The rotor 3 can be rotated both before its detachment from the object 1 to be gripped and after said detachment, for example, using the electromagnetic energy, wherein the rotor 3 can be provided with an independent drive including an electric motor 18 (see FIG. 8), and a power supply source 19 of the electric engine 18 can be positioned on both the rotor 3 (see FIG. 8) and the object 1 to be gripped, power being supplied via a mechanical link, that is, the rope 6 (see FIGS. 1, 3).

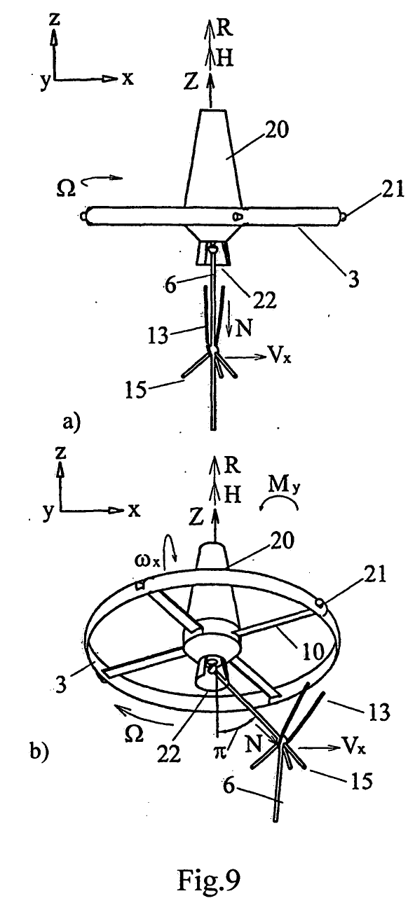

The rotor 3 can be rotated both before its detachment from the object 1 to be gripped and after said detachment, for example, using the thermal energy of combusted fuel, wherein the rotor 3 can be provided with an independent rotating drive, including a gas generator 20 having gas nozzles 21 (see FIG. 9).

The rotor 3 can be rotated before its detachment from the object 1 to be gripped, for example by direct using the mechanical rotation energy of a part of the object 1 to be gripped, for example, the energy produced by a helicopter rotor (see FIG. 2).

The rotor 3 can be rotated both before its detachment from the object 1 to be gripped and after said detachment, for example, using the mechanical rotation energy of the bar 8 being driven, for example by a part of the object 1 to be gripped, for example, a helicopter rotor (see FIG. 2).

The rotor 3 can be rotated both before its detachment from the object 1 to be gripped and after said detachment, for example, using the aerodynamic energy (see FIGS. 1, 2), wherein the rotor 3 can be provided, for example, with blades 10 positioned at an angle of attack, “α”, relative to the flow V_{∞} that flows about the rotor 3 (see FIG. 4).

Possible is rotation of the rotor 3 using the aerodynamic energy both before its detachment from the object 1 to be gripped and after detachment in the autorotation mode, i.e. possible is rotation of the rotor 3 with generation of the retaining aerodynamic force R thereon, said retaining aerodynamic force being directed at an angle “λ”, for example, to the longitudinal axis “x” of the object 1 to be gripped (see FIGS. 1, 2).

To avoid twist of the ropes 6, 7, and 9 when the rotor 3 rotates, the ropes can be secured on the rotor 3 by any members allowing a free turn of the rotor 3 relative to the axis “z” (see FIGS. 1, 3).

To reduce the energy consumed to rotate the rotor 3, it would be advantageous to begin its rotation when the object 1 to be gripped and/or the gripping object 2 reach the motion parameters needed for gripping: an altitude, a speed, an orientation, a relative position, and others (see FIGS. 1, 2, 3). A command to start the operation of the rotor 3 rotation drive can be applied both from the object 1 to be gripped (including commands from subsystems of the rotor 3 rotation drive) and the gripping object 2, for example by a radio signal.

It will be expedient to perform the orientation of the rotor 3 relative to the object 1 to be gripped a certain time period before the rotor 3 starts to rotate and in process of the rotation thereof, for example, prior to transferring at least a portion of an angular velocity Ω” to the rotor 3, said portion providing a required angular position to the angular momentum vector H (see FIGS. 1, 2, 3).

Possible is, for example, orientation of the rotor 3 before its detachment from the object 1 to be gripped by securing said rotor in a required position on the object 1 to be gripped and with the possibility of rotation relative to the object 1 of to be gripped (see FIGS. 1, 3).

Possible is, for example, orientation of the rotor 3 before its detachment from the object 1 to be gripped by securing said rotor, for example, in a required position on a part of the object 1 to be gripped, for example, on a helicopter rotor (see FIG. 2).

Possible is, for example, orientation of the rotor 3 both before its detachment from the object 1 to be gripped and after said detachment, for example by generating an orienting aerodynamic force P on the parachute 4, said orienting aerodynamic force being generated via the rope 7 on the rotor 3 as well and being directed at an angle “φ”, for example, to the longitudinal axis “x” of object 1 to be gripped, owing to the air flow that flows about the parachute 4 at a speed V_{∞} (see FIG. 1).

Possible is, for example, orientation of the rotor 3 both before its detachment from the object 1 to be gripped and after said detachment, for example by generating an orienting aerostatic force L on the aerostat 5, said orienting aerostatic force being generated via the rope 9 on the rotor 3 as well and being directed at an angle “σ”, for example, to the longitudinal axis “x” of the object 1 to be gripped (see FIG. 3).

Possible is, for example, orientation of the rotor 3 after its detachment from the object 1 to be gripped, for example by generating an orienting force of resiliency, T, on the rotor, said orienting force of resiliency being directed at an angle “χ”, for example, to the longitudinal axis “x” of the object 1 to be gripped, by selection of rigidity of the mechanical link, that is, the rope 6 and the members for securing the same (see FIGS. 1, 3).

Possible is, for example, orientation of the rotor 3 after its detachment from the object 1 to be gripped, for example by generating an orienting force of resiliency, Q, on the rotor, said orienting force of resiliency being directed at an angle “δ”, for example, to the longitudinal axis “x” of the object 1 to be gripped, by selection of rigidity characteristics of the mechanical link, that is, the bar 8 and the members for securing the same (see FIG. 2).

After transferring at least a portion of the angular velocity “Ω” to the rotor 3, the orienting aerodynamic force P can be eliminated (i.e. reduced to zero), for example by shooting off the parachute 4 with the rope 7, and mechanical engagement can be effected, for example by the hook 12 directly with the rotor 3 (see FIG. 1).

After transferring at least a portion of the angular velocity “Ω” to the rotor 3, the orienting force of resiliency, Q, can be reduced, for example by diminishing rigidity of the mechanical link, that is, the bar 8 and the members that secure the same (see FIG. 2).

After transferring at least a portion of the angular velocity “Ω” to the rotor 3, the orienting aerostatic force L can be eliminated (i.e. reduced to zero), for example by shooting off the aerostat 5 with the rope 9 (see FIG. 3).

The command to reduce the orienting force can be issued from both the object 1 (commands from subsystems of the rotor 3 rotation drive) and the gripping object 2, for example by a radio signal.

After mechanical engagement of the hooks 14 and 15 by the loop 13 (see FIGS. 2, 3), the angular velocity “Ω” of rotation of the rotor 3 can be reduced (including reduction to zero), for example by applying a braking moment thereto and/or by disengaging the rotation drive. At the same time, the command to reduce the angular velocity “Ω” of rotation of the rotor 3 can be applied, for example, based on the engagement fact from both the object 1 to be gripped and the gripping object 2, for example by a radio signal.

After mechanical engagement of the hook 15 by the loop 13 (see FIG. 13), the rotor 3 can be disengaged from the object 1 to be gripped by destruction of the rope 6 on a “rotor 3-hook 15” section (see FIG. 3). For example, when the hook 15 engaged by the loop 13 moves relatively to the rotor 3 at a horizontal velocity Vₓ, the rope 6 inclines on the “rotor 3-hook 15” section, and the tensile force N occurs in the rope (see FIG. 9a) that in turn results in occurrence of a moment M_{y} that effects upon the rotor 3, and the rotor having its own angular momentum H precesses at an angular velocity “ωₓ” (see FIG. 9b) due to its gyroscopic properties. When the “rotor 3-hook 15” section of the rope 6 is inclined at an angle “π”, a cylindrical knife 22 (schematically shown with a cut-out) mounted on the rotor 3 cuts the rope 6, thereby detaching the rotor 3 from the object 1 to be gripped (see FIG. 9b).

After mechanical engagement of the hook 15 by the loop 13 (see FIG. 3), the rotor 3 can be detached from the object 1 to be gripped according to a pre-stored program or by an additional command.

The disclosed method provides the reliable and safe gripping both the moving and stationary objects by various moveable objects, said moving and stationary objects functioning in various environments—liquid (e.g. water), gas (e.g. air), space, and others, in rescue operations, transport of freight, spacecraft mating, and others.

In particular, this method can be successfully used for gripping the spent boosters of launch vehicles to rescue them for the purpose of reuse.

1. A method for gripping an object, comprising the steps of:
detaching at least one part of an object to be gripped while maintaining a mechanical link, the detachment step being executed at least a certain time period before a moment of engagement;
retaining the detachable part at a distance from the object to be gripped, the retaining step being executed at least up to the moment of engagement by generating at least one retaining force on the at least one detachable part, said force being directed and angled to the object to be gripped;
mechanically engaging the at least one detachable part of the object to be gripped by at least one part of at least one gripping object by the spatial movement of at least a part of the latter; and
at least at a certain time period before the movement of engagement, at least partially stabilizing an angled position of the at least one detachable part relative to the object to be gripped by rotating said part to provide it with its own angular momentum corrected at an angle to the object to be gripped.

2. The method as claimed in claim 1, wherein at least one detachable part is rotated before the moment of its detachment from the object to be gripped.

3. The method as claimed in as claimed in claim 1, wherein at least one detachable part is rotated after its detachment from the object to be gripped.

4. The method as claimed in claim 1, wherein at least a portion of the retaining aerodynamic force is generated by rotating at least one detachable part relative to the axis positioned at an angle to the object to be gripped.

5. The method as claimed in claim 1, wherein at least one detachable part is rotating using the thermal energy of combusted fuel.

6. The method as claimed in claim 1, wherein at least one detachable part is rotated using the electromagnetic energy.

7. The method as claimed in claim 1, wherein at least one detachable part is rotated using the mechanical energy.

8. The method as claimed in claim 1, wherein at least one detachable part is rotated using the aerodynamic energy.

9. The method as claimed in claim 1, wherein at least a portion of the retaining force is generated by applying a reactive force to at least one detachable part of the object to be gripped, said reactive force being directed at an angle to the object to be gripped.

10. The method as claimed in claim 1, wherein at least a portion of the retaining force is generated by applying an aerostatic force to at least one detachable part of the object to be gripped, said aerostatic force being directed at an angle to the object to the gripped.

11. The method as claimed in claim 1, wherein at least one rotating detachable part of the object to be gripped is at least partially oriented relative to the object to be gripped.

12. The method as claimed in claim 11, wherein at least one rotating detachable part of the object to be gripped is oriented at least a certain time period before a moment when said part starts to rotate.

13. The method as claimed in claim 11, wherein at least one rotating detachable part of the object to be gripped is oriented in process of rotation of said part.

14. The method as claimed in claim 11, wherein at least a partial orientation is carried out by generating at least one orienting force on at least one rotating detachable part of the object to be gripped, said orienting force being directed at an angle to the object to be gripped.

15. The method as claimed in claim 14, wherein at least one orienting force is reduced in process of rotation of the rotating detachable part of the object to be gripped.

16. The method as claimed in claim 14, wherein at least a portion of the orienting force is generated by applying an aerodynamic force to at least one rotating detachable part of the object to be gripped, said aerodynamic force being directed at an angle to the object to be gripped.

17. The method as claimed in claim 14, wherein at least a portion of the orienting force is generated by applying an aerostatic force to at least one rotating detachable part of the object to be gripped, said aerostatic force being directed at an angle to the object to be gripped.

18. The method as claimed in claim 11, wherein at least a partial orientation of at least one rotating detachable part of the object to be gripped is carried out before a moment of its detachment.

19. The method as claimed in claim 11, wherein at least a partial orientation of at least one rotating detachable part of the object to be gripped is carried out after its detachment.

20. The method as claimed in claim 1, wherein an angular velocity of rotation of the rotating part of the object to be gripped is reduced at least after mechanical engagement of at least one detachable part of the object to be gripped by at least one part of at least one gripping object.
